(19) United States
(12) Patent Application Publication
(10) Pub. No.: US 2008/0077404 A1
(43) Pub. Date: Mar. 27, 2008

(54) SPEECH RECOGNITION DEVICE, SPEECH RECOGNITION METHOD, AND COMPUTER PROGRAM PRODUCT

(75) Inventors: Masami AKAMINE, Kanagawa (JP); Remco Teunen, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/850,980

(22) Filed: Sep. 6, 2007

(30) Foreign Application Priority Data
Sep. 21, 2006 (JP) 2006-255549

(51) Int. Cl. G10L 15/06

(52) U.S. Cl. 704/243; 704/E15.004

(57) ABSTRACT

A speech recognition device includes an extracting unit that analyzes an input signal and extracts a feature to be used for speech recognition from the input signal; a storing unit configured to store therein an acoustic model that is a stochastic model for estimating what type of a phoneme is included in the feature; a speech-recognition unit that performs speech recognition on the input signal based on the feature and determines a word having maximum likelihood from the acoustic model; and an optimizing unit that dynamically self-optimizes parameters of the feature and the acoustic model depending on at least one of the input signal and a state of the speech recognition performed by the speech-recognition unit.

### CROSS-REFERENCE TO RELATED APPLICATIONS

This application is based upon and claims the benefit of priority from the prior Japanese Patent Application No. 2006-255549, filed on Sep. 21, 2006; the entire contents of which are incorporated herein by reference.

### BACKGROUND OF THE INVENTION

1. Field of the Invention

The present invention relates to a speech recognition device, a speech recognition method, and a computer program product.

2. Description of the Related Art

In speech recognition, an acoustic model, which is a stochastic model, is used for estimating what types of phonemes are included in a feature. A hidden Markov model (HMM) is generally used as the acoustic model. A feature of each state of the HMM is represented by a Gaussian mixture model (GMM). The HMM generally corresponds to each phoneme and the GMM is a statistical model of the feature of each state of the HMM that is extracted from a received speech signal. In the conventional method, all the GMMs are calculated by using the same feature, also the feature is constant even if the state of speech recognition changes.

Moreover, in the conventional method, it is not possible to change the GMM depending on the state of the speech recognition, so that it is not possible to achieve sufficient recognition performance. In other words, in the conventional method, parameters of the acoustic model (for example, context dependency structure, number of models, number of Gaussian distributions, and covalent structures of the model and state) are set when creating the acoustic model, and those parameters are not changed as the speech recognition proceeds.

If speech recognition is performed in a noisy place, for example, inside a running vehicle, the noise level of the speech signal keeps changing drastically. Thus, if one can dynamically change the acoustic model depending on the noise level, it is possible to increase the accuracy of the speech recognition. However, the conventional acoustic model is static in that it does not change with the noise level. Therefore, enough recognition accuracy can not be obtained with the conventional acoustic model.

Furthermore, in the conventional acoustic model, the same feature is used for speech recognition even if conditions or states are changed. For example, even if each state of an HMM has the same phoneme, the effective feature of each state of the HMM is different by location within a word. However, the feature cannot be changed in the conventional acoustic model. Therefore, enough recognition accuracy can not be obtained with the conventional acoustic model.

Furthermore, when speech recognition is executed in a noisy place, it is obvious that a fricative sound has different effective feature and parameters of the acoustic model from the same for a vowel sound. However, in the conventional acoustic model, the effective feature and the parameters of the acoustic model cannot be changed. Therefore, enough recognition accuracy can not be obtained with the conventional acoustic model.

A prospective word is selected from an acoustic model and a language model by decoding and determined as a recognition word. A one-pass decoding method or a multi-pass (generally, two-pass) decoding method are used to perform decoding. In the two-pass decoding method, it is possible to change the acoustic model between the first and second passes. Therefore, the appropriate acoustic model can be used depending on a gender of a speaker or a noise level. Such process of decoding is described, for example, in the following cited references:

Schwartz R., Austin S., Kubala F., Makhoul J., Nguyen L., Placeway P., Zavaglios G., “New Uses for the N-best Sentence Hypotheses within the Byblos Speech Recognition System”, Proc. ICASSP 92, pp. 1-4, San Francisco, USA, 1992.

Rayner M., Carter D., Digalakis V., and Price P., “Combining Knowledge Sources to Reorder N-best Speech Hypothesis Lists”, In Proceedings ARPA Human Language Technology Workshop, pages 212-217, ARPA, March 1994.

In the two-pass decoding method, it is possible to change the acoustic model between the first and second passes so that a certain degree of recognition accuracy can be obtained.

However, even in the two-pass decoding method, it is not possible to optimize the feature depending on the states of speech recognition. Moreover, it is not possible to optimize parameters of the acoustic model on a frame basis because the acoustic model can be selected on a phonation basis. In other words, even in the two-pass decoding method, enough recognition accuracy can not be obtained.

### SUMMARY OF THE INVENTION

According to an aspect of the present invention, a speech recognition device includes a feature extracting unit that analyzes an input signal and extracts a feature to be used for speech recognition from the input signal; an acoustic-model storing unit configured to store therein an acoustic model that is a stochastic model for estimating what type of a phoneme is included in the feature; a speech-recognition unit that performs speech recognition on the input signal based on the feature and determines a word having maximum likelihood from the acoustic model; and an optimizing unit that dynamically self-optimizes parameters of the feature and the acoustic model depending on at least one of the input signal and a state of the speech recognition performed by the speech-recognition unit.

According to another aspect of the present invention, a computer-readable recording medium that stores therein a computer program product that causes a computer to execute a plurality of commands for speech recognition that is stored in the computer program product, the computer program product causing the computer to execute analyzing an input signal and extracting a feature to be used for speech recognition from the input signal; performing speech recognition of the input signal based on the feature and determining a word having maximum likelihood from the acoustic model that is a stochastic model for estimating what type of a phoneme is included in the feature; and dynamically self-optimizing parameters of the feature and the acoustic model depending on the input signal or a state of the speech recognition performed by the performing.

According to still another aspect of the present invention, a speech recognition method includes analyzing an input signal and extracting a feature to be used for speech recognition from the input signal; performing speech recognition of the input signal based on the feature and determining a word having maximum likelihood from the acoustic model that is a stochastic model for estimating what type of a phoneme is included in the feature; and dynamically self-optimizing parameters of the feature and the acoustic model depending on the input signal or a state of the speech recognition performed by the performing.

### BRIEF DESCRIPTION OF THE DRAWINGS

FIG. 1 is a block diagram of a hardware configuration of a speech recognition device according to an embodiment of the present invention;

FIG. 2 is a block diagram of a functional configuration of the speech recognition device;

FIG. 3 is a schematic for explaining an example of a data structure of a hidden Markov model (HMM);

FIG. 4 is a schematic for explaining a relationship between the HMM and a decision tree;

FIG. 5 is a tree diagram for explaining a configuration of the decision tree;

FIG. 6 is a tree diagram of an example of the decision tree;

FIG. 7 is a flowchart for explaining a process for calculating the likelihood of a model with respect to a feature; and

FIG. 8 is a flowchart for explaining a learning process to the decision tree.

### DETAILED DESCRIPTION OF THE INVENTION

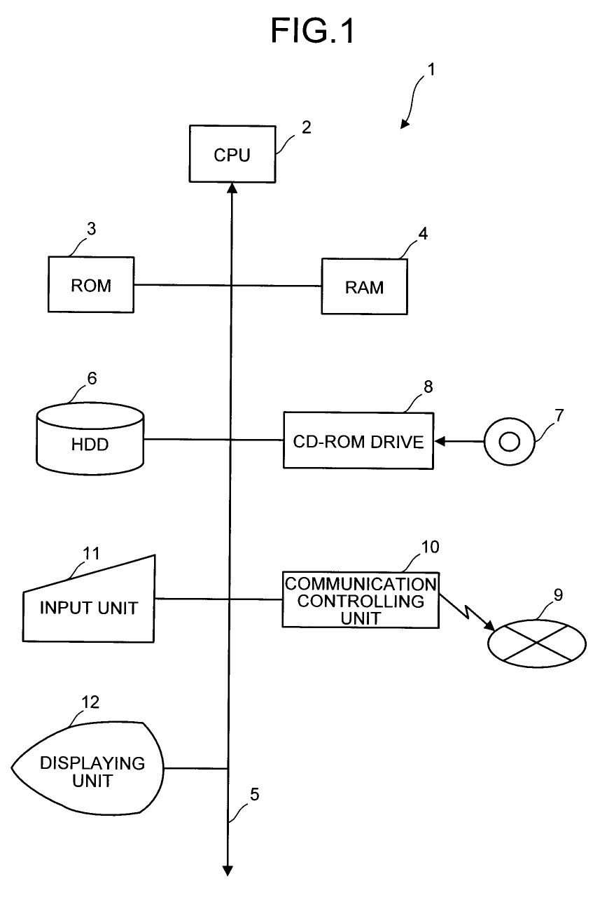

Exemplary embodiments of the present invention are explained in detail below with reference to the accompanying drawings. FIG. 1 is a block diagram of a hardware configuration of a speech recognition device 1 according to an embodiment of the present invention. The speech recognition device 1 is, for example, a personal computer, and includes a central processing unit (CPU) 2 that controls the speech recognition device 1. The CPU 2 is connected to a read only memory (ROM) 3 and a random access memory (RAM) 4 via a bus 5. The ROM 3 stores therein basic input/output system (BIOS) information and the like. The RAM 4 rewritably stores therein data, thereby serving as a CPU buffer of the CPU 2.

A hard disk drive (HDD) 6, a compact disc ROM (CD-ROM) drive 8, a communication controlling unit 10, an input unit 11, and a displaying unit 12 are connected to the bus 5 via respective input/output (I/O) interfaces (not shown). The HDD 6 stores therein computer programs and the like. The CD-ROM drive 8 is configured to read a CD-ROM 7. The communication controlling unit 10 controls communicating between the speech recognition device 1 and a network 9. The input unit 11 includes a keyboard or a mouse. The speech recognition device 1 receives operational instructions from a user via the input unit 11. The displaying unit 12 is configured to and display information thereon and includes a cathode ray tube (CTR), a liquid crystal display (LCD), and the like.

The CD-ROM 7 is a recording medium that stores therein computer software such as an operating system (OS) or a computer program. When the CD-ROM drive 8 reads a computer program stored in the CD-ROM 7, the CPU 2 installs the computer program on the HDD 6.

Incidentally, instead of the CD-ROM 7 it is possible to use, for example, an optical disk such as a digital versatile disk (DVD), a magnetic optical disk, a magnetic disk such as a flexible disk (FD), and a semiconductor memory. Furthermore, instead of using a physical recording medium such as the CD-ROM 7, the communication controlling unit 10 can be configured to download a computer program from the network 9 via the Internet, and the downloaded computer program can be stored in the HDD 6. In such a configuration, a transmitting server needs to include a storage unit such as the recording medium as described above to store therein the computer program. The computer program can be activated by using a predetermined OS. The OS can perform some of processes. The computer program can be included in a group of computer program files that includes predetermined applications software and OS.

The CPU 2 controls operations of the entire speech recognition device 1, and performs each process based on the computer program loaded on the HDD 6.

Of the functions that the computer program installed on the HDD 6 causes the CPU 2 to execute, a function included in the speech recognition device 1 is described in detail below.

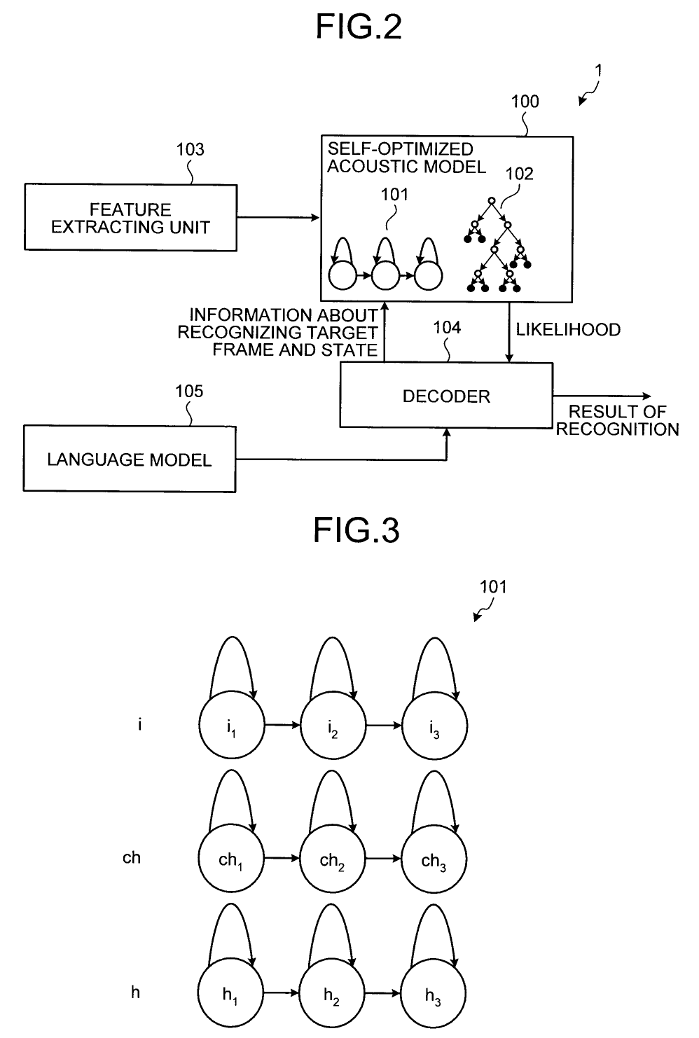

FIG. 2 is a block diagram of a functional configuration of the speech recognition device 1. The speech recognition device 1 includes a self-optimized acoustic model 100 as an optimizing unit, a feature extracting unit 103, a decoder 104 as a recognizing unit, and a language model 105. The speech recognition device 1 performs speech recognition processing by using the self-optimized acoustic model 100.

An input signal (not shown) is input to the feature extracting unit 103. The feature extracting unit 103 extracts a feature to be used for speech recognition from the input signal by analyzing the input signal, and outputs the extracted feature to the self-optimized acoustic model 100. Various types of acoustic features can be used as the feature. Alternatively, it is possible to use high-order features such as a gender of a speaker, a phonemic context, etc. As examples of the high-order features, a thirty-nine dimensional acoustic feature that is a combination of static features of Mel frequency cepstrum coefficients (MFCCs) or perceptual linear predictive (PLP) static features, delta (primary differentiation) and delta delta (secondary differentiation) parameters, and energy parameters, those are used in the conventional speech recognition method, a class of gender, and a class of the signal to noise ratio (SNR) of an input signal are used for speech recognition.

The self-optimized acoustic model 100 includes a hidden Markov model (HMM) 101 and a decision tree 102. The decision tree 102 is a tree diagram that is hierarchized at each branch. The HMM 101 is identical to that is used in the conventional speech recognition method. One or a plurality of the decision tree(s) 102 corresponds to Gaussian mixture models (GMMs) used as the feature of each state of the HMM in the conventional speech recognition method. The self-optimized acoustic model 100 is used to calculate a likelihood of a state of the HMM 101 with respect to a speech feature input from the feature extracting unit 103. The likelihood denotes the plausibility of a model, i.e., how the model explains a phenomenon and how often the phenomenon occurs with the model.

The language model 105 is a stochastic model for estimating the types of contexts each word is used. The language model 105 is identical to that is used in the conventional speech recognition method.

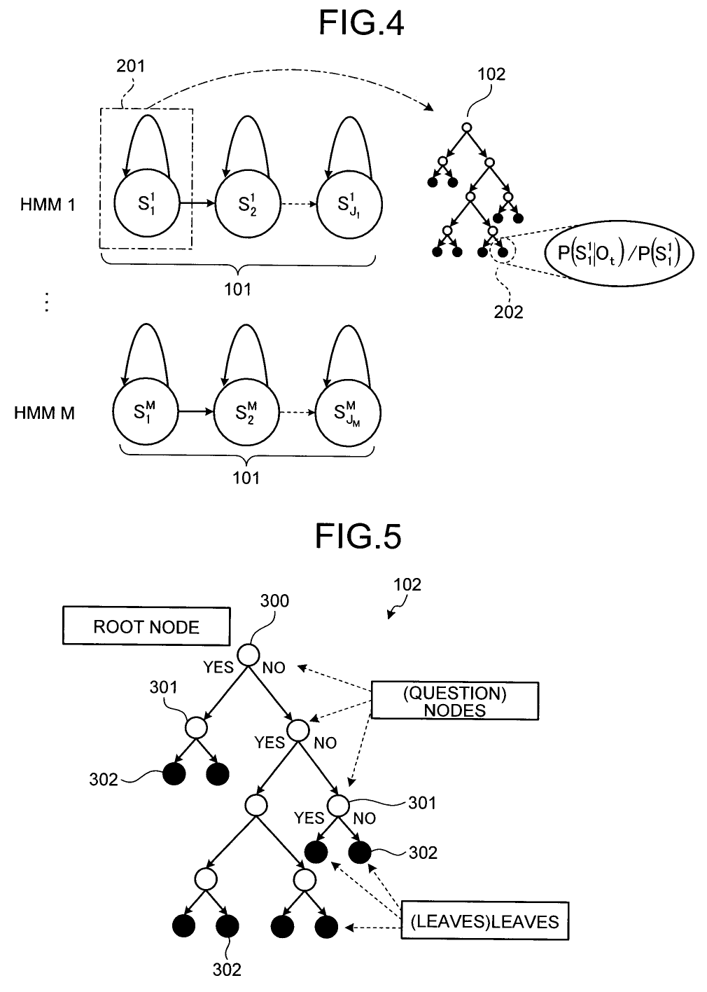

The decoder 104 calculates the likelihood of each word, and determines a word having a maximum likelihood (see FIG. 4) in the self-optimized acoustic model 100 and the language model 105 as a recognition word. Specifically, upon receiving results of the likelihood from the self-optimized acoustic model 100, the decoder 104 transmits information about a recognizing target frame such as a phonemic context of a state of the HMM and a state of speech recognition in the decoder 104 to the self-optimized acoustic model 100. The phonemic context denotes a portion of a string of phonemes that compose a word.

The HMM 101 and the decision tree 102 are described in detail below.

In the HMM 101, feature time-series data and a label of each phoneme that are output from the feature extracting unit 103 are recorded in associated manner. FIG. 3 is a schematic for explaining an example of a data structure of the HMM 101. In the HMM 101, the feature time-series data is represented by a finite automaton that includes nodes and directed links. Each of the nodes indicates a state of verification. For example, nodes i1, i2, and i3 correspond to the same phoneme “i”, but have a different state respectively. Each of the directed links is associated with the state transition probability (not shown) between states.

FIG. 4 is a schematic for explaining a relationship between the HMM 101 and the decision tree 102. The HMM 101 includes a plurality of states 201. Each of the states 201 is associated with the decision tree 102.

An operation of the decision tree 102 is described in detail below with reference to FIG. 5. The decision tree 102 includes a node 300, a plurality of nodes 301, and a plurality of leaves 302. The node 300 is a root node, i.e., it is the topmost node in the tree structure. Each of the nodes 300 and 301 has two child nodes: “Yes” and “No”. The child node can be either the node 301 or the leaf 302. Each of the nodes 300 and 301 has a question about the feature that is set in advance, thereby branching into two child nodes, “Yes” and “No”, depending on the answer of the question. Each of the leaves 302 has neither a question nor child nodes, but outputs the likelihood (see FIG. 4) with respect to a model included in received data. The likelihood is calculated by the way of a learning process, and stored in each of the leaves 302 in advance.

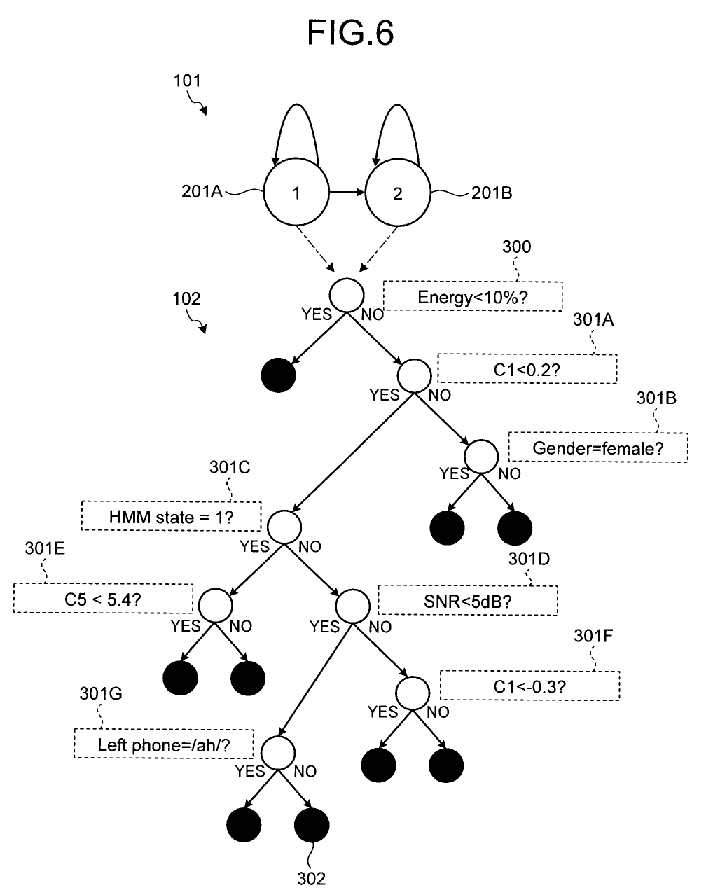

FIG. 6 is a tree diagram of an example of the decision tree 102. As shown in FIG. 6, an acoustic model according to the embodiment can output the likelihood depending on a speaker's gender, the SNR, a state of speech recognition, and a context of an input speech. The decision tree 102 is related to two states of the HMM 101: state 1 (201A), and state 2 (201B). The decision tree 102 performs a learning process by using learning data corresponding to the states 201A and 201B. Features C1 and C5 respectively denote the first and the fifth PLP cepstrum coefficients. The root node 300, and nodes 301A and 301B are shared by the states 201A and 201B, and applied to the states 201A and 201B. A node 301C has a question about a state. Nodes 301D to 301G depend on a state of the node 301C. Namely, some features are used in common between the states 201A and 201B, but the other features are used depending on a state. In addition, the number of the features used depending on a state is not constant. In the example shown in FIG. 6, the state 2 (201B) uses more features compared with the state 1 (201A). The likelihood changes depending on whether the SNR is lower than five decibels, i.e., the surrounding noise level is high or low, or whether a previous phoneme of the target phoneme is “/ah/”. In the node 301B, a question is whether a speaker's gender of the input speech is female. Namely, the likelihood changes depending on the speaker's gender.

Parameters of the number of the nodes and leaves of the decision tree 102, features and questions that are used in each node, the likelihood output from each leaf, and the like are determined by the learning process based on learning data. Those parameters are optimized to obtain the maximum likelihood and the maximum recognition rate. If the learning data includes enough data, and also if the speech signal is obtained in the actual place where speech recognition is executed, the decision tree 102 is also optimized in the actual environment.

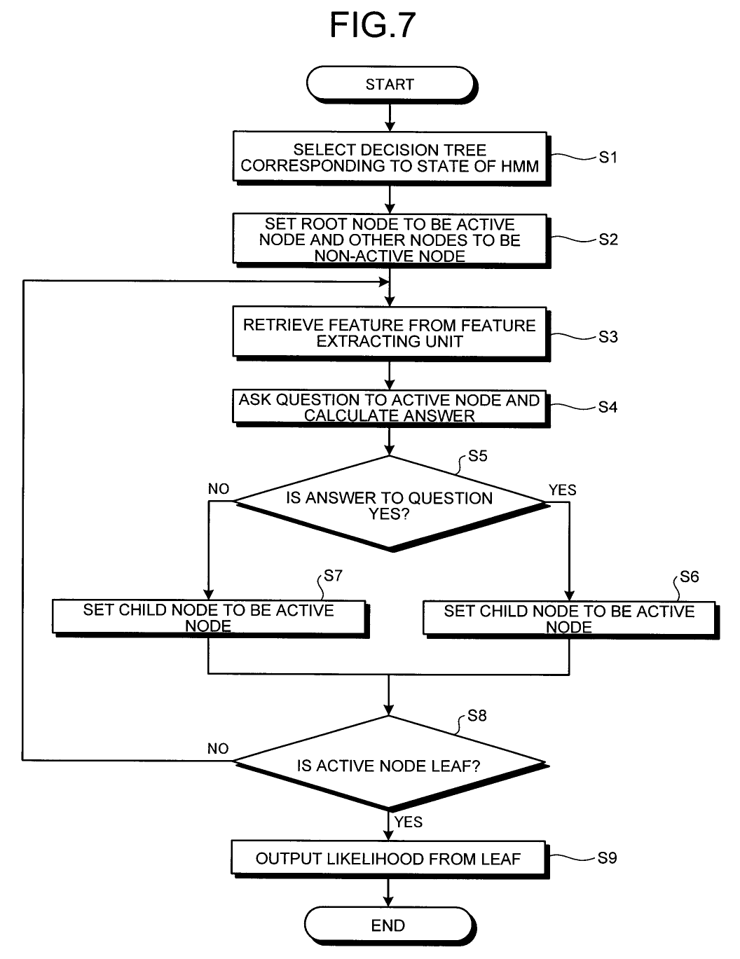

Processes performed by the self-optimized acoustic model 100 for calculating the likelihood of each state of the HMM 101 with respect to received features are described in detail below with reference to FIG. 7.

First, the decision tree 102 corresponding to a certain state of the HMM 101 that indicates a target phoneme is selected (step S1).

Subsequently, the root node 300 is set to be an active node, i.e., a node that can ask a question, while the nodes 301 and the leaves 302 are set to be non-active nodes (step S2). Then, a feature that corresponds to the data set at the steps S1 and S2 is retrieved from the feature extracting unit 103 (step S3).

By using the retrieved feature, the root node 300 calculates an answer to the question that is stored in the root node 300 in advance (step S4). It is determined whether the answer to the question is “Yes” (step S5). If the answer is “Yes” (Yes at step S5), a child node indicating “Yes” is set to be an active node (step S6). If the answer is “No” (No at step S5), a child node indicating “No” is set to be an active node (step S7).

Then, it is determined whether the active node is the leaf 302 (step S8). If the active node is the leaf 302 (Yes at step S8), the likelihood stored in the leaf 302 is output because the leaf 302 is not branched any more to other node (step S9). If the active node is not the leaf 302 (No at step S8), the system control proceeds to step S3.

As described above, the features, the questions about the features, and the likelihood those depending on an input are written in the acoustic model using the decision tree 102. Therefore, the decision tree 102 can effectively optimize the acoustic features, questions relating to high-order features, and the likelihood depending on an input signal or a state of recognition. The optimization can be achieved by the learning process that is explained in detail below.

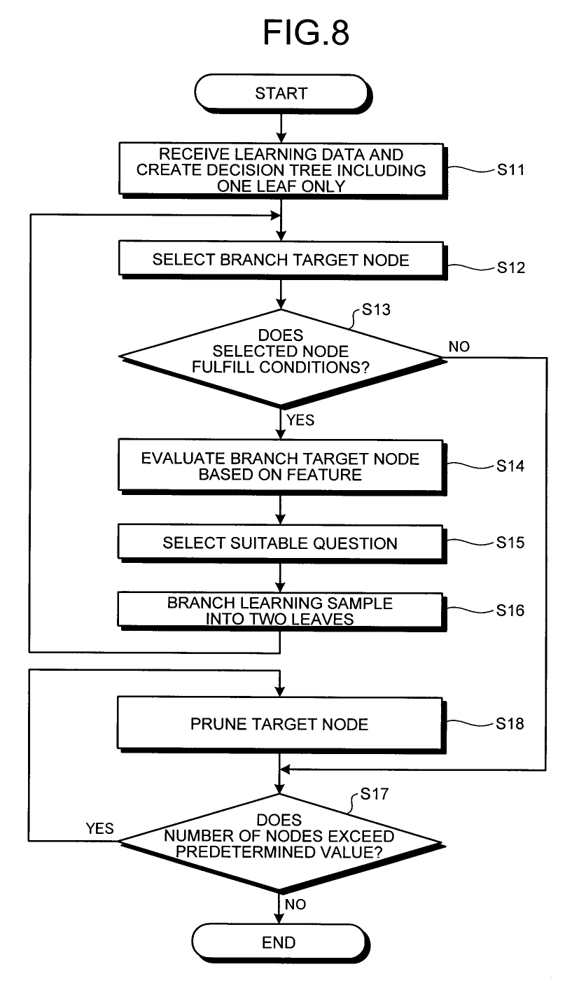

FIG. 8 is a flowchart for explaining the learning process to the decision tree 102. Learning to the decision tree 102 is basically to determine a question, which is required for identifying whether an input sample belongs to a certain state of the HMM 101 corresponding to the target decision tree 102, and the likelihood by using a learning sample that is separated into classes based on whether the input sample belongs to the state of the HMM 101 in advance. The learning sample is used for force alignment to determine whether the input sample relates to which state of the HMM 101 by using the general speech recognition method, and then labels a sample belonging to the state as a true class and a sample non-belonging to the state as other class in advance. Incidentally, learning to the HMM 101 can be performed in the same manner as in the conventional method.

A learning sample of a target state corresponding to the decision tree 102 is input and the decision tree 102 including only one number of the root node 300 (step S11) is created. In the decision tree 102, the root node 300 branches into nodes, and the nodes further branches into child nodes.

Then, a target node to be branched is selected (step S12). Incidentally, the node 301 needs to include a certain amount of learning samples (for example, a hundred or more learning samples), and also the learning samples need to be composed by a plurality of classes.

It is determined whether the target node fulfills the above conditions (step S13). If the result of the determination is “No” (No at step S13), the system control proceeds to step S17 (step S18). If the result of the determination is “Yes” (Yes at step S13), all available questions about all features (learning samples) input to the target node 301 are asked and all branches (into child nodes) that are obtained by answers to the questions are evaluated (step S14). The evaluation at the step S14 is performed based on the increasing rate of the likelihood caused by the branches of the nodes. The questions about the features, which are the learning samples, are different depending on the features. For example, the question about the acoustic feature is expressed by either large or small. The question about the gender or types of noises is expressed by a class. Namely, if the feature is expressed by either large or small, the question is whether the feature exceeds a threshold. On the other hand, if the feature is expressed by a class, the question is whether the feature belongs to a certain class.

Then, a suitable question to optimize the evaluation is selected (step S15). In other words, all the available questions to all the learning samples are evaluated, and a question to optimize the increasing rate of the likelihood is selected.

In accordance with the selected question, the learning sample is branched into two leaves 302: “Yes” and “No”. Then, the likelihood of each of the leaves 302 is calculated based on the learning sample belonging to each of the branched leaves (step S16). The likelihood of a leaf L is calculated by the following Equation:

Likelihood stored at leaf L=P(true class|L)/P(true class) and the result of the calculation is stored in the leaf L,

where P(true class|L) denotes the posterior probability of the true class in the leaf L, and P(true class) denotes the prior probability of the true class.

Then, the system control returns to the step S12, and the learning process is performed to a new leaf. The decision tree 102 grows each time the steps S12 to S16 are repeated. In the event, if there is no target node that fulfills the conditions (No at step S13), pruning target nodes are pruned (steps S17 and S18). The pruning target nodes are pruned (deleted) from bottom up, i.e., from the lowest-order node to the highest-order node. Specifically, all the nodes having two child nodes are evaluated for the decrease in the likelihood when the child nodes are deleted. The node in which the least likelihood decreases is pruned (step S18) repeatedly until the number of the nodes drops below a predetermined value (step S17). If the number of the nodes drops below the predetermined value (No at step S17), a first round of the learning process to the decision tree 102 is terminated.

When the learning process to the decision tree 102 is terminated, the force alignment is performed on a speech sample for learning by using the learned acoustic model, thereby updating the learning sample. The likelihood of each leaf of the decision tree 102 are updated by using the updated learning sample. Those processes are repeatedly performed by predetermined times or until the increasing rate of the entire likelihood drops below a threshold, and then the learning process is completed.

In this manner, parameters of features and acoustic models can be dynamically self-optimized depending on the level of the input signal or the state of speech recognition. In other words, it is possible to optimize parameters of the acoustic models, for example, types and the number of features, which include not only acoustic features but also high-order features, the number of commoditized structures and sharing, the number of states, the number of context depending models, depending on conditions and states of input speech, phonemic recognition, and speech recognition. As a result, high recognition performance can be achieved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A speech recognition device comprising:
a feature extracting unit that analyzes an input signal and extracts a feature to be used for speech recognition from the input signal;
an acoustic-model storing unit configured to store therein an acoustic model that is a stochastic model for estimating what type of a phoneme is included in the feature;
a speech-recognition unit that performs speech recognition on the input signal based on the feature and determines a word having maximum likelihood from the acoustic model; and
an optimizing unit that dynamically self-optimizes parameters of the feature and the acoustic model depending on at least one of the input signal and a state of the speech recognition performed by the speech-recognition unit.

2. The speech recognition device according to claim 1, wherein
the optimizing unit includes a decision tree that is hierarchized by branches,
a plurality of leaves that is located in distal ends of the decision tree and respectively stores therein likelihood with respect to the acoustic model, and
the likelihood depending on the input signal and a state of the speech recognition is selected by selecting a desired leaf from the leaves.

3. The speech recognition device according to claim 2, wherein the decision tree is constructed by a learning process that determines a question and likelihood those required for identifying whether an input sample belongs to a certain state of the acoustic model corresponding to the decision tree that is a learning target by using a learning sample that is separated into classes based on whether the input sample belongs to the certain state in advance.

4. The speech recognition device according to claim 1, wherein
the acoustic model stored in the acoustic-model storing unit is a hidden Markov model (HMM), and
a likelihood of the feature in each state is calculated by using the decision tree.

5. A computer-readable recording medium that stores therein a computer program product that causes a computer to execute a plurality of commands for speech recognition that is stored in the computer program product, the computer program product causing the computer to execute:
analyzing an input signal and extracting a feature to be used for speech recognition from the input signal;
performing speech recognition of the input signal based on the feature and determining a word having maximum likelihood from the acoustic model that is a stochastic model for estimating what type of a phoneme is included in the feature; and
dynamically self-optimizing parameters of the feature and the acoustic model depending on the input signal or a state of the speech recognition performed by the performing.

6. The computer-readable recording medium according to claim 5, wherein the self-optimizing includes
storing likelihood with respect to the acoustic model respectively in a plurality of leaves that is located in distal ends of a decision tree that is hierarchized by branches, and
selecting the likelihood depending on the input signal and a state of the speech recognition by selecting a desired leaf from the leaves.

7. The computer-readable recording medium according to claim 6, further comprising constructing the decision tree by a learning process that includes determining a question and likelihood those required for identifying whether an input sample belongs to a certain state of the acoustic model corresponding to the decision tree that is a learning target by using a learning sample that is separated into classes based on whether the input sample belongs to the certain state in advance.

8. The computer-readable recording medium according to claim 5, wherein
the acoustic model is a hidden Markov model (HMM), and
a likelihood of the feature in each state is calculated by using the decision tree.

9. A speech recognition method comprising:
analyzing an input signal and extracting a feature to be used for speech recognition from the input signal;
performing speech recognition of the input signal based on the feature and determining a word having maximum likelihood from the acoustic model that is a stochastic model for estimating what type of a phoneme is included in the feature; and
dynamically self-optimizing parameters of the feature and the acoustic model depending on the input signal or a state of the speech recognition performed by the performing.

10. The method according to claim 9, wherein the self-optimizing includes
storing likelihood with respect to the acoustic model respectively in a plurality of leaves that is located in distal ends of a decision tree that is hierarchized by branches, and
selecting the likelihood depending on the input signal and a state of the speech recognition by selecting a desired leaf from the leaves.

11. The method according to claim 10, further comprising constructing the decision tree by a learning process that includes determining a question and likelihood those required for identifying whether an input sample belongs to a certain state of the acoustic model corresponding to the decision tree that is a learning target by using a learning sample that is separated into classes based on whether the input sample belongs to the certain state in advance.

12. The method according to claim 9, wherein
the acoustic model is a hidden Markov model (HMM), and
a likelihood of the feature in each state is calculated by using the decision tree.
